(19) United States
(12) Patent Application Publication
(10) Pub. No.: US 2024/0170742 A1
(43) Pub. Date: May 23, 2024

(54) INTELLIGENT SAMPLING OF BATTERY CELLS FOR IN-DEPTH QUALITY EVALUATION AND ANALYSIS

(71) Applicant: Liminal Insights, Inc., Emeryville, CA (US)

(72) Inventors: Vivek BHAGAT, Fremont, CA (US); Shaurjo BISWAS, El Cerrito, CA (US); Austin Ryan DULANEY, Emeryville, CA (US)

(73) Assignee: Liminal Insights, Inc., Emeryville, CA (US)

(21) Appl. No.: 18/518,435

(22) Filed: Nov. 22, 2023

Related U.S. Application Data
(60) Provisional application No. 63/384,817, filed on Nov. 23, 2022.

(51) Int. Cl. H01M 10/42; G01N 29/04; G01N 29/26

(52) U.S. Cl. CPC H01M 10/4285; G01N 29/04; G01N 29/262; G01N 2291/0289; G01N 2291/106; G01N 2291/2698

(57) ABSTRACT

Provided is an approach for fast and efficient analysis of acoustic signals to detect anomalies in battery cells and using the results of such analysis for intelligent selection of a subset of battery cells for in-depth quality control analysis. In one aspect, a system includes a first acoustic scanner configured to scan a battery cell; determine if the battery cell is potentially anomalous or not; and send the battery cell for a high-resolution scan if the battery cell is determined to be potentially anomalous. The system further includes a second acoustic scanner configured to perform a high-resolution scan of the battery cell; and one of confirm that the battery cell is defective or to determine that the battery cell is defect-free

### CROSS REFERENCE TO RELATED APPLICATIONS

This application claims the benefit of U.S. Provisional Application No. 63/384,817, filed on Nov. 23, 2022, and entitled “Processes For Anomaly And Defect Detection And Intelligent Sampling Of Battery Cells For In-Depth Analysis”, the content of which is hereby incorporated by reference in their entirety and for all purposes.

### FIELD OF DISCLOSURE

The present disclosure is directed to systems used for monitoring and inspection of batteries based on acoustic signals. More specifically, exemplary aspects are directed to several processes for identification of battery cells with defects and more intelligent sampling of battery cells for in-depth quality evaluation and control during battery manufacturing.

### BACKGROUND

Demand for production of battery cells is on the rise owing to an increase in their use across various industries such as consumer electronics, automotive, clean energy, etc. Efficient and fast battery diagnostics methods are important for increasing quality, lifetime, and manufacturing process efficiency for batteries. In the case of manufacturing and production, reducing costs (e.g., price per kilowatt-hour (kWh)) is an important goal. Production costs and quality can be reduced by optimizing existing processes and/or introducing new technologies. For example, technological advances in the area of improved monitoring, manufacturing, and diagnostics can lead to cost efficiencies by shortening production process times (thus also reducing energy consumption during production), reducing waste due to damaged cells and cell parts, improving quality, etc.

### BRIEF DESCRIPTION OF THE DRAWINGS

The accompanying drawings are presented to aid in the description of various aspects of the disclosure and are provided solely for illustration and not limitation.

FIG. 1 illustrates an example system for analyzing a sample using acoustic signal-based analysis, according to some aspects of the present disclosure;

FIG. 2 illustrates another example system for analyzing a sample using acoustic signal-based analysis, according to some aspects of the present disclosure;

FIG. 3 illustrates an example implementation for intelligent sampling of battery cells for in-depth quality evaluation and control analysis, according to some aspects of the present disclosure;

FIG. 4 illustrates an example process for intelligent sampling of battery cells for in-depth quality evaluation and control analysis, according to some aspects of the present disclosure; and

FIG. 5 illustrates an example computing device architecture of an example computing device, in accordance with some aspects of the disclosure.

### SUMMARY

The present disclosure provides an approach for fast and efficient analysis of acoustic signals to detect anomalies in battery cells and using the results of such analysis for intelligent selection of a subset of battery cells for in-depth quality evaluation and analysis.

In one aspect, a system includes a first acoustic scanner configured to scan a battery cell; determine if the battery cell is potentially anomalous or not; and send the battery cell for a high-resolution scan if the battery cell is determined to be potentially anomalous. The system further includes a second acoustic scanner configured to perform a high-resolution scan of the battery cell; and one of confirm that the battery cell is defective or to determine that the battery cell is defect-free.

In another aspect, the first acoustic scanner is an array configured to perform a fast and low-resolution scan of the battery cell.

In another aspect, the second acoustic scanner is a rastering scanner configured to perform the high-resolution scan.

In another aspect, the second acoustic scanner is configured to identify a type of defect present in the battery cell.

In another aspect, upon confirming that the battery cell is defective, the battery cell is selected for an in-depth analysis.

In another aspect, the in-depth analysis includes a CT scan of the battery cell, subject the battery cell to long term cycling, or performing a tear down analysis of the battery cell.

In another aspect, the system is deployed on a battery cell manufacturing line.

In another aspect, the first acoustic scanner is configured to determine if the battery cell is potentially defective using a defect detection technique.

In another aspect, the defect detection technique utilizes a trained neural network.

In another aspect, the second acoustic scanner is configured to one of confirm that the battery cell is defective or determine that the battery cell is defect-free, using a trained neural network.

In another aspect, the first acoustic scanner is configured to scan the battery cell in less than 10 seconds.

In another aspect, a duration of the high-resolution scan is longer than a duration of the scan performed by the first acoustic scanner.

In another aspect, the system includes at least two second acoustic scanners for each first acoustic scanner.

In another aspect, the defective battery cell has one or more of plating of lithium metal on an anode, dry spots, air or gas bubbles within the battery cell, physical or chemical variation in anode or cathode electrode compositions, on-surface or subsurface electrode defects, electrode misalignment, electrode folds, separator holes, folds, and wrinkles, foreign object debris or particulate inclusions, insufficient electrolyte, incorrect electrolyte formulation, incomplete solid-electrolyte-interphase buildup, or tab welding.

In another aspect, the first acoustic scanner is configured to generate a probability for the potentially defective battery cell.

### DETAILED DESCRIPTION

Certain aspects and embodiments of this disclosure are provided in the following description and related drawings. Alternate aspects may be devised without departing from the scope of the disclosure. Additionally, well-known elements of the disclosure will not be described in detail or will be omitted so as not to obscure the relevant details of the disclosure.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the disclosure. As used herein, the singular forms “a,” “an,” and “the” are intended to include the plural forms as well, unless the context clearly indicates otherwise. It will be further understood that the terms “comprises”, “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Demand for production of battery cells is on the rise owing to an increase in their use across various industries such as consumer electronics, automotive, clean energy, etc. Efficient and fast battery diagnostics methods are important for increasing quality, lifetime, and manufacturing process efficiency for batteries. In the case of manufacturing and production, reducing costs (e.g., price per kilowatt-hour (kWh)) is an important goal. Production costs and quality can be reduced by optimizing existing processes and/or introducing new technologies. For example, technological advances in the area of improved monitoring, manufacturing, and diagnostics can lead to cost efficiencies by shortening production process times (thus also reducing energy consumption during production), reducing waste due to damaged cells and cell parts, improving quality, etc.

One example aspect of monitoring and diagnosing a battery cell during the manufacturing process is identification and labeling of defects (various known or to be developed physical defects such presence of foreign objects, non-uniform Solid Electrolyte Interphase (SEI) formation, etc.) based on information captured through acoustic signals that are transmitted through the battery cell and captured using pairs of transceivers.

There are a number of battery defects that can lead to poor battery cell performance, a catastrophic battery (and/or device) failure, etc. Such defects can arise during the manufacturing process or during regular operation. Such defects are difficult to detect because they are generally deep within the battery cell and hidden from non-invasive imaging methods or are not substantial enough to be detected through electrical inspection methods until the defect has caused substantial damage/degradation to the battery. The systems and techniques described herein can provide a way to non-destructively detect battery defects before they become catastrophic.

In some examples, manufacturing defects can include, but are not limited to, folds, wrinkles, or holes in traditional polymer-based separator materials; cracks or fractures in solid-state ceramic based separators; dry spots within the cell due to poor electrolyte saturation; electrode holes, folds, delamination, or layer misalignment; foreign object debris, burrs, metallic particle inclusions; tab defects including tears, folds, and poor-quality welds, non-uniform Solid Electrolyte Interphase (SEI) formation, etc.

Operational defects can include, for example and without limitation, the plating of lithium metal (e.g., dendritic growth or otherwise) on the anode material, dry spots within the cell due to electrolyte degradation, the evolution of gasses resulting from electrolyte or other chemical decomposition, among others. All of these defects can cause micro-shorts in the battery that, if allowed to propagate, can lead to early cell death, rapid loss of capacity, and/or catastrophic failure.

Presently available methods for detecting these defects would be either X-ray scans, destructive teardown imaging and analysis of the cells, long term cycling, etc. X-ray scans are unable to detect operational defects like Li-plating and electrolyte degradation, and manufacturing defects related to the folding, wrinkling, or puncturing of separator materials as well as electrolyte saturation issues. High precision electrical measurements and camera or laser-based optical inspection may also be used. There are other solutions that cover subsets of ultrasound inspection for battery defects.

When conducting ultrasonic tests on batteries, the wide parameter space on the test apparatus and the sample form factor can lead to challenges involving non-recurring engineering and design tasks. For example, a subset of ultrasonic test settings may be optimized to see a folded separator in a pouched Lithium-ion battery, but may not be able to see electrode inclusions in the same cell. Conversely, observing a separator fold may require different ultrasonic settings in prismatic cells versus pouch cells. The wide parameter space within ultrasound as it pertains to testing batteries can require that the test system be designed so that different transducer types can be accommodated, different test methodologies can be executed electronically, and/or that the test bed can accommodate most of the common battery form factors.

Ultrasonic tests are also highly influenced by external factors. Even in the most basic tests, results can vary drastically with fluctuations in mechanical alignment, contact force, external temperature, pressure and environment, as well as within the ultrasonic coupling used to transfer the ultrasonic pulse from the transducer to the test component. A robustly designed ultrasonic test system as described herein can factor all of these challenges in order to produce accurate and reproducible results.

In some aspects of the present disclosure, systems, apparatuses, methods (also referred to as processes), and computer-readable media (collectively referred to herein as “systems and techniques”) are described for detecting defects inside of batteries that result from anomalies, inconsistencies, errors, or flaws that occur during the manufacturing process as well as those that develop during operation using our ultrasonic testing equipment, signal processing pipeline, and advanced analytics platform. This methodology includes the use of ultrasonic sensors to send acoustic signals into battery cells, the recording of the response signals, the processing of those signals, the extraction of meaningful features and metrics from those signals, and finally the use of the metrics to construct machine learning models to predict the presence of specific defects. Ultrasonic inspection platforms disclosed herein can take measurements at multiple positions across the cell to provide high spatially resolved scans which are used to assess cell quality. An analysis pipeline may then be used to autonomously identify the presence of defects within the scanned cell, where those defects are, and what the specific defect type is based on the results from our analytics platform mentioned above. This results in a segmented image of the cell that highlights the size, location, and type of defects present.

In manufacturing thousands of cells, existing in-depth quality evaluation and control techniques (e.g., X-rays, tear downs, long term cycling, and/or other know or emerging electrical inspection techniques) are costly. Hence, batch testing is utilized when a subset of cells in a given batch are randomly selected to undergo such in-depth quality evaluation and control. As the name suggests, this selection process is random and may defect free cells may be subjected to such in-depth quality evaluation and control that can take several days. This is inefficient as a defective battery cell that is manufactured may not be selected for in-depth analysis. At the same time, subjecting every single cell to a detailed and in-depth acoustic measurement, of which systems disclosed herein are capable, would also be costly and time consuming. This is also inefficient.

To address these inefficiencies, disclosed is a process whereby acoustic measurements systems of the present disclosure may be deployed in a two-stage process to select with high degree of confidence defective cells for in-depth quality evaluation and control, thus minimizing or eliminating the possibility of wasting time and resources on in-depth analysis of defect free cells through the random process, or allowing defective cells to escape the manufacturing line undetected.

According to the disclosed two-stage process, all or nearly all cells on a cell manufacturing line are subjected to a first stage of this two-stage process. In one example, in this stage, a relatively quick array scanning is performed on each cell in order to make an initial determination as to whether the given cell under testing is anomalous or not. Those cells flagged as possibly anomalous may then undergo the second stage of this two-stage process that involves a more in-depth acoustic scan to either confirm the anomalous cell is in fact defective or reverse the determination of the first stage. This two-stage process results in identification of defective cells with a high degree of confidence. Cells that may then be selected for more in-depth quality evaluation and control using existing methods, may then be selected from this group of identified defective cells. This results in an intelligent and highly effective process for selecting cells to the time consuming and costly processes such as X-rays, tear downs, long term performance cycling, etc., which may take several weeks to complete.

The systems and techniques described herein for detecting defects in batteries can address the foregoing challenges (as well as other challenges).

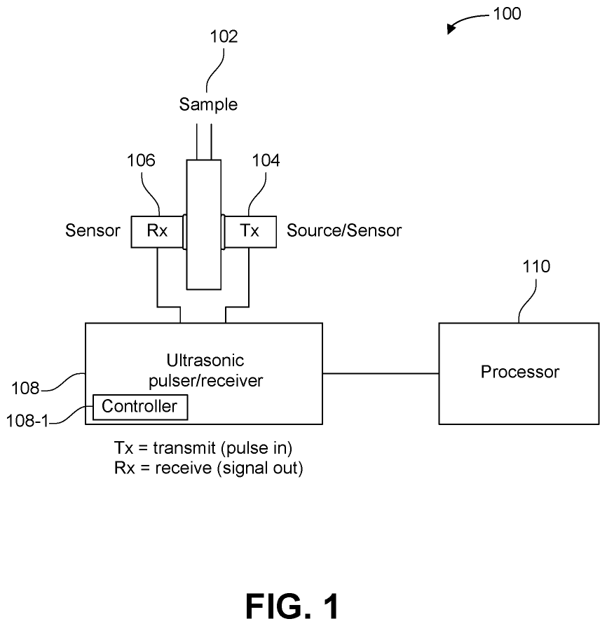

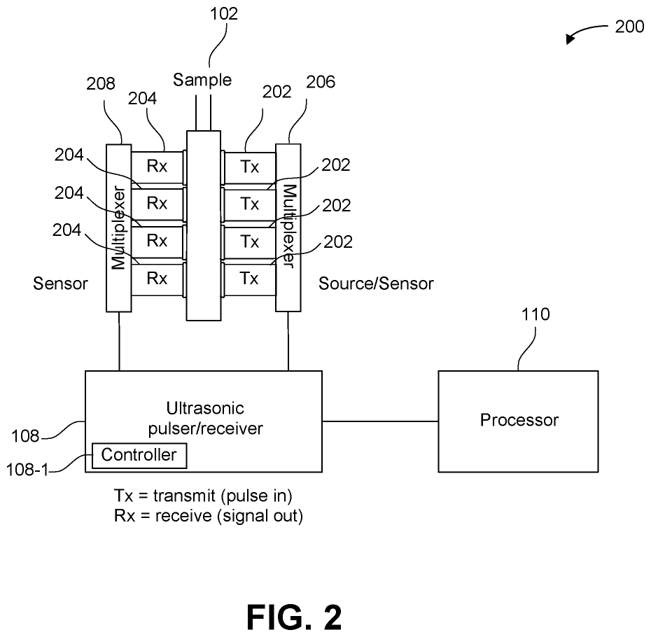

Initially example systems that may be deployed to implement the two-stage intelligent cell selection for in-depth quality evaluation and control is described with reference to FIGS. 1 and 2.

FIG. 1 illustrates an example system for analyzing a sample using acoustic signal-based analysis, according to some aspects of the present disclosure. System 100 may include sample 102. Sample 102 can include a battery cell or component thereof in any stage of production or manufacture of the battery cell or the individual components. In some examples, sample 102 can include a battery cell, electrolytes in various stages of wetting/distribution through a battery cell, one or more electrodes of the battery cell, thin films, separators, coated sheets, current collectors, electrode slurries, or materials for forming any of the above components during any stage of their formation. System 100 can include a transmitting transducer Tx 104 or other means for sending excitation sound signals into the battery cell (e.g., for transmitting a pulse or pulses of ultrasonic or other acoustic waves, vibrations, resonance measurements, etc., through the battery cell). System 100 can further include a receiving transducer Rx 106 or other means for receiving/sensing the sound signals, which can receive response signals generated from signals transmitted by Tx transducer 104. Any type of known or to be developed transducer for transmitting and receiving acoustic signals may be used as Tx transducer 104. Transmitted signals from Tx transducer 104, from one side of sample 102 on which Tx transducer 104 is located, may include input excitation signals. Reflected signals, e.g., from another side of sample 102, may include echo signals. It is understood that references to response signals may include both the input excitation signals and the echo signals. Further, Tx transducer 104 may also be configured to receive response signals, and similarly, Rx transducer 106 may also be configured to transmit acoustic signals. Any type of known or to be developed transducer for transmitting and receiving acoustic signals may be used as Rx transducer 106. Therefore, even though separately illustrated as Tx and Rx, the functionalities of these transducers may be for both sending and receiving acoustic signals. In various alternatives, even if not specifically illustrated, one or more Tx transducers and one or more Rx transducers can be placed on the same side or wall of sample 102, or on different (e.g., opposite) sides. Throughout this disclosure, reference may be made to a transducer pair (a transmitting transducer and a receiving transducer). Transducer Tx 104 and transducer Rx 106 may form a pair of transducers.

Acoustic pulser/receiver 108 can be coupled to Tx and Rx transducers 104, 106 for controlling the transmission of acoustic signals (e.g., ultrasound signals) and receiving response signals. Acoustic pulser/receiver 108 may include a controller 108-1 for adjusting the amplitude, frequency, and/or other signal features of the transmitted signals. Acoustic pulser/receiver 108 may also receive the signals from Rx transducers 106. In some examples, acoustic pulser/receiver 108 may be configured as a combined unit, while in some examples, an acoustic pulser for transmitting excitation signals through Tx transducer 104 can be a separate unit in communication with a receiver for receiving signals from Rx transducer 106. Processor 110 in communication with acoustic pulser/receiver 108 may be configured to store and analyze the response signal waveforms according to this disclosure. Although representatively shown as a single processor, processor 110 can include one or more processors, including remote processors, cloud computing infrastructure, etc.

Although not explicitly shown in FIG. 1, more than one Tx transducer and/or more than one Rx transducer can be placed in one or more spatial locations across sample 102. This allows studying a spatial variation of acoustic signal features across sample 102. A multiplexer can be configured in communication with the acoustic pulser/receiver 108 for separating and channeling the excitation signals to be transmitted and the response signals received. In some examples, various acoustic couplants can be used (e.g., solid, liquid, or combinations thereof) for making or enhancing contact between Tx and Rx transducers 104, 106 and sample 102. Furthermore, various attachment or fixturing mechanisms (e.g., pneumatic, compression, screws, etc.) can also be used for establishing or enhancing the contact between Tx and Rx transducers 104, 106 and sample 102.

FIG. 2 illustrates another example system for analyzing a sample using acoustic signal-based analysis, according to some aspects of the present disclosure. In comparison with FIG. 1, system 200 of FIG. 2 illustrates a system in which multiple pairs of transmitting and receiving transducers are used for transmitting signals through a sample under testing (e.g., a battery cell) and performing acoustic signal-based analysis of the sample.

System 200 includes several transmitting Tx transducers 202 (each of which may be the same as Tx transducer 104 of FIG. 1). While an array of four examples Tx transducers 202 are shown in FIG. 2, the disclosure is not limited to four. Any number of transducers may be used (e.g., any number of Tx transducers ranging from 1 to 10, 15, 20, etc.).

Similarly, system 200 includes a number of receiving (sensing) Rx transducers 204 (each of which may be the same as Rx transducer 106 of FIG. 1). While an array of four examples Rx transducers 204 are shown in FIG. 2, the disclosure is not limited to four. Any number of transducers may be used (e.g., any number of Rx transducers ranging from 1 to 10, 15, 20, etc.). Any given Tx transducer 202 and Rx transducer 204 may form a transducer pair (FIG. 2 illustrates four transducer pairs). FIG. 2 also illustrates a multiplexer 206 coupled to the array of four Tx transducers 202 and a multiplexer 208 coupled to the array of four Rx transducers 204. As described above, each one of multiplexers 206 and 208 may be configured in communication with the acoustic pulser/receiver 108 for separating and channeling the excitation signals to be transmitted and the response signals received, respectively. In some examples, various acoustic couplants can be used (e.g., solid, liquid, or combinations thereof) for making or enhancing contact between Tx and Rx transducers 202, 204 and sample 102. Furthermore, various attachment or fixturing mechanisms (e.g., pneumatic, compression, screws, etc.) can also be used for establishing or enhancing the contact between Tx and Rx transducers 202, 204 and sample 102.

Spacing between Tx transducers 202 and Rx transducers 204 may be uniform and the same. System 200 also includes additional elements such as sample 102, ultrasonic pulser/receiver 108 (controller 108-1), processors 110, each of which may be the same as the corresponding counterpart described above with reference to FIG. 1 and hence will not be described further for sake of brevity.

Although two example systems are described with reference to FIGS. 1 and 2 for acoustic measurement and analysis of battery cells, the present disclosure is not limited thereto and other known or to be developed acoustic measurement systems may be utilized. As a non-limiting example, a rastering system for acoustic inspection of battery cells, as developed by Liminal Insights, Inc. of Emeryville, CA and described in U.S. application Ser. No. 18/109,482 filed on Feb. 14, 2023, the entire content of which is incorporated herein by reference, may also be utilized.

As noted above, in battery cell production, hundreds to thousands of cells are produced each day. Currently, 100% of the cells from a cell manufacturing line are inspected with fast electrochemical methods to determine quality, but a very small fraction (typically <0.1%) are randomly selected in each manufactured batch for detailed quality assessment with electrochemical methods that can take days to weeks. Cell characteristics determined with these long electro-chemical tests methods are used to determine the quality of the entire batch. Such random sampling per batch often does not catch bad or defective cells, which can make it out into the field, and result in poor performance or safety issues. Using techniques disclosed herein, instead of such random selection of cells for batch testing, every cell during cell manufacturing (at different cell manufacturing stages) can be examined in a two-stage process and anomalous cells can be flagged for further inspection. These flagged cells can then be sent for longer-term, detailed quality assessment (in-depth quality evaluation and control using X-ray, long term cycling, tear down analysis, etc.). Using ultrasound inspection for rapid assessment of cell quality to down-sample for further review is a replacement of the commonly practiced random sampling per batch in the battery industry. This targeted sampling method increases the odds of selecting a bad or defective cell to inspect with more time and resource intensive methods, increasing the utilization of expensive inspection equipment, reducing the potential for faulty cells to make it into the field, and potentially preventing the unnecessary destruction of good quality cells.

A specific use case as an example is when large LIB prismatic cells were scanned post-formation with this described ultrasound inspection method to determine the cell quality based on cycle life performance prediction. The cells that were predicted to perform poorly were flagged and then reviewed with high resolution acoustic scanning, teardown image analysis and/or other complimentary electrical test methods to determine the defects in the cells. This method allows for targeted sampling of cells in the batch to determine the defects causing quality issues, instead of trying to find defective cells by random sampling in the batch.

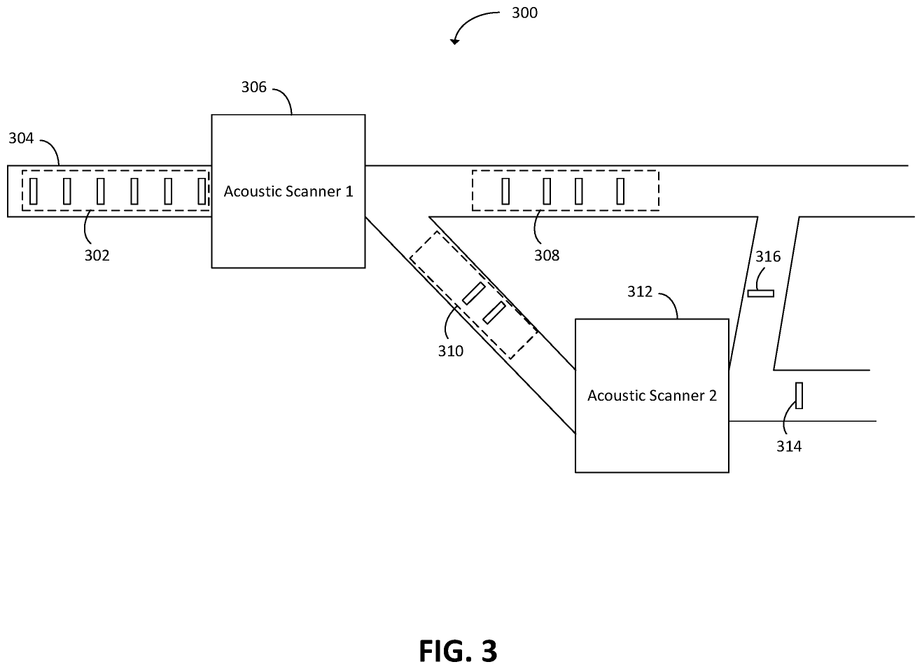

With reference to FIGS. 3-5, a process is described whereby acoustic measurements systems of the present disclosure (e.g., systems 100 and 200 of FIG. 1 and FIG. 2, rastering system, etc.) may be deployed in a two-stage process to select, with a high degree of confidence, defective cells for in-depth quality evaluation and control, thus minimizing or eliminating the possibility of wasting time and resources on in-depth analysis of defect free cells through the random process as well as missing inspection and diagnosis of defective cells that are not selected through the random process.

According to the disclosed two-stage process, all or nearly all cells on a cell manufacturing line are subjected to a first stage of this two-stage process. In one example, in this stage, a relatively quick array scanning is performed on each cell in order to make an initial determination as to whether the given cell under testing is anomalous or not. Those cells flagged as possibly defective may then undergo the second stage of this two-stage process that involves a more in-depth acoustic scan to either confirm the anomalous cell is in fact defective or reverse the determination of the first stage. This two-stage process results in identification of defective cells with a high degree of confidence. Cells that may then be selected for more in-depth quality evaluation and control using existing methods, may then be selected from this group of identified defective cells. This results in an intelligent and highly effective process for selecting cells, perform further detailed analysis using the time consuming and costly processes such as X-rays, tear downs, long term cycling, etc., which may take several days/weeks to complete.

FIG. 3 illustrates an example implementation for intelligent sampling of battery cells for in-depth quality evaluation and control analysis, according to some aspects of the present disclosure. In example set up 300 of FIG. 3, a series of battery cells 302 may progress through a particular stage of cell manufacturing on a conveyor belt such as belt 304.

A system of acoustic scanners formed of acoustic scanner 1 306 and acoustic scanner 2 308 may be deployed on belt 304. There may be more than one acoustic scanner 1 and one acoustic scanner 2 deployed. Acoustic scanner 1 306 may be any of systems 100 or 200 of FIGS. 1 and 2 (e.g., an array scanner performing a multi-channel acoustic scan of a battery cell). Acoustic scanner 2 308 may be a rastering scanner configured to perform a much more granular acoustic scan of a battery cell.

In one example, there may be two or three acoustic scanners 2 for every acoustic scanner 1 since each acoustic scanner 2 may take several minutes to complete a single scan of a battery cell while acoustic scanner 1 may perform the initial scan in a few seconds.

Each of battery cells 302 may be subject to a first stage of a two-stage scan using acoustic scanner 1 306. As mentioned, this first stage is a relatively quick scan. In other words, all cells 302 are subject to the first scan by acoustic scanner 1 306. In one example, acoustic scanner 1 306 may scan cells 302 at a rate of 10 parts per minute (ppm).

In one example, acoustic scanner 1 306 may acoustically scan each of cells 302 and perform defect detection using the captured acoustic signals that are indicative of physical characteristics and/or defects present in a given cell 302 that is undergoing testing. Such defect detection may result in initial determination that the cell may contain an anomaly. Acoustic scanner 1 306 may perform this anomaly detection using any known or to be developed defect detection techniques. Such techniques may utilize a trained neural network configured to receive input data indicative of acoustic response signals captured after transmission through a cell 302 and provide, as output, an indication of a possible defective cell (possible anomaly). Non-limiting examples of such defect detection techniques are described in U.S. application Ser. No. 18/518,387 filed on Nov. 23, 2023, and U.S. application Ser. No. 18/109,521 filed on Feb. 14, 2023, the entire contents of which are incorporated herein by reference. However, the present disclosure is not limited thereto and other known or to be developed techniques including those developed by Liminal Insights, Inc. of Emeryville, CA may also be utilized.

Any cell not flagged as potentially defective or otherwise anomalous, may then proceed to subsequent manufacturing stages and/or packaging for shipment. For instance, cells 308 are shown as a subset of cells 302 not flagged as defective or otherwise having an anomaly by acoustic scanner 1 306.

In one example, cells flagged as potentially defective or anomalous may have a probability (e.g., expressed as a number between 0-1 or as a percentage between 0-100%) associated therewith that can indicate a probability that a corresponding cell is defective/has an anomaly. Cells flagged as potentially defective or otherwise anomalous (e.g., cells 310), may then traverse (be diverted) along another path on belt 304 to be subjected to a much more granular and detailed acoustic scan using acoustic scanner 2 312. As noted, acoustic scanner 2 312 may be high resolution rastering scanner described above. A rastering scanner is configured to scan and inspect prismatic, pouch, and/or cylindrical cells of varying dimensions. The scan area and the distance between each measurement point can be customized to the millimeter level for the necessary/desired cell coverage and resolution.

Techniques utilized by acoustic scanner 2 312 may be any known or to be developed defect detection technique including, but not limited to, defect detection techniques described in U.S. application Ser. No. 18/518,387 filed on Nov. 23, 2023, and U.S. application Ser. No. 18/109,521 filed on Feb. 14, 2023, the entire contents of which are incorporated herein by reference. However, the present disclosure is not limited thereto and other known or to be developed techniques including those developed by Liminal Insights, Inc. of Emeryville, CA may also be utilized. At this stage, a high-resolution scan by acoustic scanner 2 312 either reverses the decision made by acoustic scanner 1 306 regarding possible defect/anomaly or confirms that a given cell from subset 310 of cells flagged by acoustic scanner 1 306 as defective, are in fact defective. The high-resolution scan may further identify the type of defect or anomaly present in a given one of cells 310.

If a given one of cells 308 is confirmed as being defective (e.g., cell 314 in FIG. 3), that cell may be transferred into a rejected batch of cells, which may then be subject to in-depth quality evaluation and control using know methods such as X-ray (CT scan), tear down analysis, long term cycling, etc. Accordingly, defective cells may be intelligently and with a high degree of confidence selected for in-depth quality evaluation and control as opposed to the currently utilized random selection process.

However, if acoustic scanner 2 312 determines that the initial flag by acoustic scanner 1 306 about an anomaly/possible defect is incorrect (i.e., the particular cell in subset 310 is defect/anomaly free), then such cell (e.g., cell 316) may join other defect free cells (e.g., cells 308) to proceed to next stages of manufacturing, packaging, etc.

While in example setting of FIG. 3, acoustic scanner 1 306 and acoustic scanner 2 are shown as two different physical units at two different locations along belt 304, the present disclosure is not limited thereto. In one example, a single physical structure (unit) may contain both acoustic scanner 1 306 and acoustic scanner 2 312.

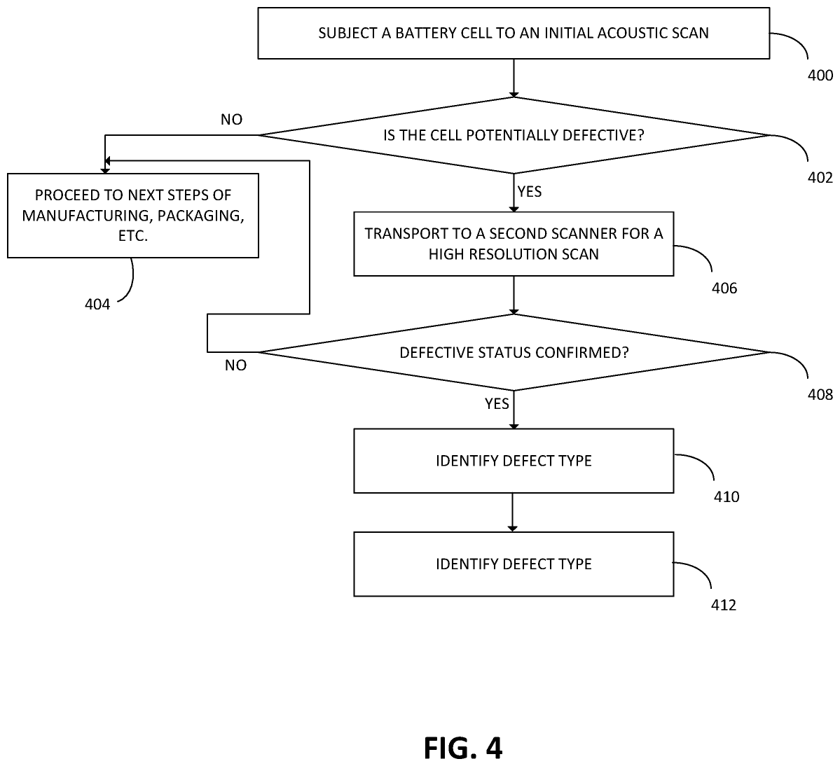

FIG. 4 illustrates an example process for intelligent sampling of battery cells for in-depth quality evaluation and control analysis, according to some aspects of the present disclosure.

At step 400, a battery cell is subject to an initial acoustic scan using acoustic scanner 1 306. As noted above, all cells going through the cell manufacturing process may be subject to the initial acoustic scan at step 400.

At step 402, acoustic scanner 1 306 determines if a scanned battery cell is anomalous (potentially defective) or not. Acoustic scanner may utilize any of the above-described defect detection techniques to identify the scanned cell as potentially defective or not.

If not, at step 404, the scanned cell may proceed to next steps in the manufacturing process, may be packaged for shipment to customers at the end of the production line, etc.

However, if the scanned cell is flagged as anomalous, at step 406, the flagged cell may be transported for a second stage acoustic scan using acoustic scanner 2 312. The scan at this stage may be a high-resolution scan to either (1) confirm that the scanned cell is in fact defective (and/or contains anomalies) as indicated by the result of the initial scan at step 402, or (2) determine that the scanned cell (initially identified as potentially defective) is not defective and can be placed with other cells initially identified as not defective (OK cells) such as cells 308.

At step 408, and based on the high-resolution scan by acoustic scanner 2 312, it is determined whether the defective status of the cell subject is confirmed or not.

If not confirmed (i.e., the scanned cell initially identified as anomalous is now confirmed by the high-resolution scan that it is defect free), the process may proceed back to step 404 and the subject cell may move to next steps in the manufacturing process, may be packaged to be shipped to customers, etc.

If confirmed, at step 410, the high-resolution scan may also identify the type of defect present in the scanned cell. Thereafter, at step 412, the cell may be selected for in-depth quality evaluation and control (e.g., CT scans, long term cycling, tear down analysis, etc.). In one example, the identified type of defect may also be passed along, which together with the results of the in-depth quality evaluation and control, can be used to update/retrain neural networks used by acoustic scanner 1 306 and/or acoustic scanner 2 312 for future detection and/or identification of defects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Accordingly, an aspect of the invention can include a computer-readable media embodying a method of improvements to one or more processes in the manufacturing of battery cells using acoustic signal-based analysis. Accordingly, the invention is not limited to illustrated examples and any means for performing the functionality described herein are included in aspects of the invention.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

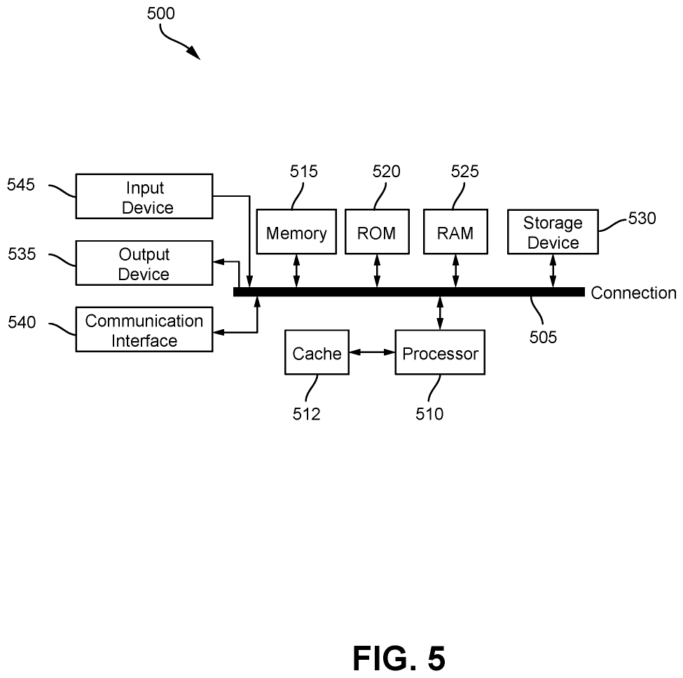

FIG. 5 illustrates an example computing device architecture of an example computing device, in accordance with some aspects of the disclosure. Device architecture 500 of an example computing device which can be used as various components of system 100 or 200 (e.g., processor 110) implement various techniques described herein. The components of the computing device architecture 500 are shown in electrical communication with each other using a connection 505, such as a bus. The example computing device architecture 500 includes a processing unit (CPU or processor) 510 and a computing device connection 505 that couples various computing device components including the computing device memory 515, such as read only memory (ROM) 520 and random-access memory (RAM) 525, to the processor 510.

The computing device architecture 500 can include a cache of high-speed memory connected directly with, in close proximity to, or integrated as part of the processor 510. The computing device architecture 500 can copy data from the memory 515 and/or the storage device 530 to the cache 512 for quick access by the processor 510. In this way, the cache can provide a performance boost that avoids processor 510 delays while waiting for data. These and other modules can control or be configured to control the processor 510 to perform various actions. Other computing device memory 515 may be available for use as well. The memory 515 can include multiple different types of memory with different performance characteristics. The processor 510 can include any general-purpose processor and a hardware or software service stored in storage device 530 and configured to control the processor 510 as well as a special-purpose processor where software instructions are incorporated into the processor design. The processor 510 may be a self-contained system, containing multiple cores or processors, a bus, memory controller, cache, etc. A multi-core processor may be symmetric or asymmetric.

To enable user interaction with the computing device architecture 500, an input device 545 can represent any number of input mechanisms, such as a microphone for speech, a touch-sensitive screen for gesture or graphical input, keyboard, mouse, motion input, speech and so forth. An output device 535 can also be one or more of a number of output mechanisms known to those of skill in the art, such as a display, projector, television, speaker device. In some instances, multimodal computing devices can enable a user to provide multiple types of input to communicate with the computing device architecture 500. The communication interface 540 can generally govern and manage the user input and computing device output. There is no restriction on operating on any particular hardware arrangement and therefore the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 525, read only memory (ROM) 520, and hybrids thereof. The storage device 530 can include software, code, firmware, etc., for controlling the processor 510. Other hardware or software modules are contemplated. The storage device 530 can be connected to the computing device connection 505. In one aspect, a hardware module that performs a particular function can include the software component stored in a computer-readable medium in connection with the necessary hardware components, such as the processor 510, connection 505, output device 535, and so forth, to carry out the function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A system comprising:
a first acoustic scanner configured to:
scan a battery cell;
determine if the battery cell is potentially anomalous or not; and
send the battery cell for a high-resolution scan if the battery cell is determined to be potentially anomalous; and
a second acoustic scanner configured to:
perform a high-resolution scan of the battery cell; and
one of confirm that the battery cell is defective or to determine that the battery cell is defect-free.

2. The system of claim 1, wherein the first acoustic scanner is an array configured to perform a fast and low-resolution scan of the battery cell.

3. The system of claim 1, wherein the second acoustic scanner is a rastering scanner configured to perform the high-resolution scan.

4. The system of claim 1, wherein the second acoustic scanner is configured to identify a type of defect present in the battery cell.

5. The system of claim 1, wherein upon confirming that the battery cell is defective, the battery cell is selected for an in-depth analysis.

6. The system of claim 5, wherein the in-depth analysis includes a CT scan of the battery cell, subject the battery cell to long term cycling, or performing a tear down analysis of the battery cell.

7. The system of claim 1, wherein the system is deployed on a battery cell manufacturing line.

8. The system of claim 1, wherein the first acoustic scanner is configured to determine if the battery cell is potentially anomalous using a defect detection technique.

9. The system of claim 8, wherein the defect detection technique utilizes a trained neural network.

10. The system of claim 1, wherein the second acoustic scanner is configured to one of confirm that the battery cell is defective or determine that the battery cell is defect-free, using a trained neural network.

11. The system of claim 1, wherein the first acoustic scanner is configured to scan the battery cell in less than 10 seconds.

12. The system of claim 1, wherein a duration of the high-resolution scan is longer than a duration of the scan performed by the first acoustic scanner.

13. The system of claim 1, wherein the system includes at least two second acoustic scanners for each first acoustic scanner.

14. The system of claim 1, wherein the defective battery cell has one or more of plating of lithium metal on an anode, dry spots, air or gas bubbles within the battery cell, physical or chemical variation in anode or cathode electrode compositions, on-surface or subsurface electrode defects, electrode misalignment, electrode folds, separator holes, folds, and wrinkles, foreign object debris or particulate inclusions, insufficient electrolyte, incorrect electrolyte formulation, incomplete solid-electrolyte-interphase buildup, or tab welding.

15. The system of claim 1, wherein the first acoustic scanner is configured to generate a probability for the potentially defective battery cell.
